(19) United States
(12) Patent Application Publication
(10) Pub. No.: US 2014/0033179 A1
(43) Pub. Date: Jan. 30, 2014

(54) APPLICATION TESTING

(71) Applicants: Michael Gustus, Herzeliya (IL); Erez Sela, Tikva (IL); Roy Nuriel, Hachartzit (IL)

(72) Inventors: Michael Gustus, Herzeliya (IL); Erez Sela, Tikva (IL); Roy Nuriel, Hachartzit (IL)

(73) Assignee: Hewlett-Packard Development Company LP

(21) Appl. No.: 13/561,685

(22) Filed: Jul. 30, 2012

(51) Int. Cl. G06F 11/36

(52) U.S. Cl. 717/127

(57) ABSTRACT

An application testing module running on a virtual machine environment includes a trigger for taking a snapshot of the virtual machine environment while an application under test is running on the virtual machine environment.

### BACKGROUND

Identifying and addressing bugs in computer applications is often tedious and time-consuming. Reproducing a defect in an application for analysis may necessitate that the application be run for several hours or even days to reach the point of failure in a test script of the application.

### BRIEF DESCRIPTION OF THE DRAWINGS

FIG. 1 is a schematic illustration of an example application testing system.

FIG. 2 is a schematic illustration of an example implementation of application testing with the testing system of FIG. 1.

FIG. 3 is a flow diagram of an example method for generating a test script with a trigger for a snapshot.

FIG. 4 is a diagram of an example test script that may be generated using the method of FIG. 3.

FIG. 5 is a flow diagram of an example method for capturing a snapshot based on a trigger.

FIG. 6 is a flow diagram of an example method for modifying testing during a pause in the running of a test script from a snapshot.

### DETAILED DESCRIPTION OF THE EXAMPLE EMBODIMENTS

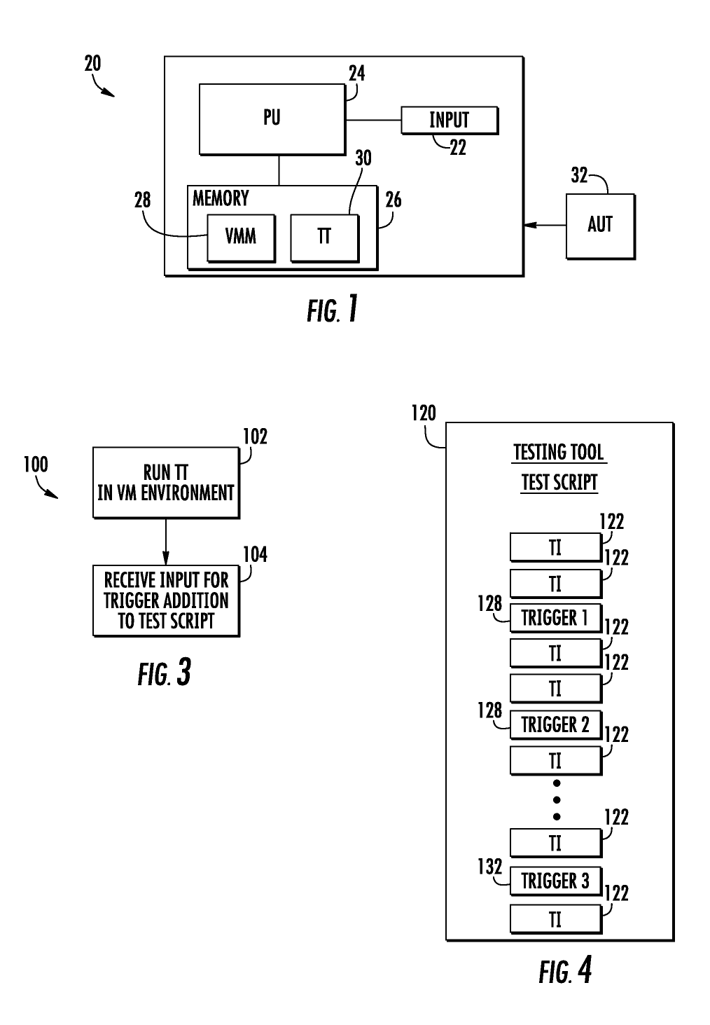

FIG. 1 schematically illustrates an example application testing system 20. Application testing system 20 facilitates the testing and debugging of computer applications (application under test). As will be described hereafter, application testing system 20 facilitates the testing of computer applications in an efficient and less time-consuming manner.

Application testing system 20 comprises input 22, processing unit 24 and memory 26 which includes virtual memory module 28 and testing tool 30. Input 22 comprises one or more devices by which commands, instructions or data may be entered or input into system 20. Examples of input 22 include, but are not limited to, a keyboard, a touchpad, a touch screen, a mouse, a stylus, a microphone with associated speech recognition software, a wireless communication device, and an electronic port for receiving data or commands.

Processing unit 24 comprises one or more processing units which carry out instructions contained in virtual memory module 28 and testing tool 30 of memory 26. Processing unit 24 comprise the physical hardware for carrying out the testing of an application under test 32. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, the controller or processing unit 24 may be embodied as part of one or more application-specific integrated circuits (ASICs). Unless otherwise specifically noted, the controller is not limited to any specific combination of hardware circuitry and software, nor to any particular source for the instructions executed by the processing unit.

Memory 26 comprises a non-transient computer-readable medium or persistent storage device containing code for directing processing unit 24 in carrying out the testing of application 32. Memory 26 includes virtual memory module 28 and testing tool 30. Virtual memory module 28 comprises computer-readable programming or code a direct processing unit 24 to establish a virtual machine environment, wherein a virtual machine agent or hypervisor operating or running on a host environment or host operating system of system 20 communicates with the virtual machine environment. The virtual machine environment established by module 28 facilitates the running or operation of testing tool 30 in the virtual machine environment, isolating the testing tool from the host environment and allowing the host environment to possibly host additional testing tools testing it other applications in different virtual machine environments.

Testing tool module 30 comprises software or code to carry out a testing application on the application under test 32. Testing tool module or testing tool 30 generates a test script for the application under test 32 and runs the application under test according to the test script in the virtual machine environment. A test script is a script of simulated user manipulations or inputs to the application under test. As will be described hereafter, testing tool module 30 incorporates one or more triggers in the test script, wherein the virtual machine manager in the host environment captures snapshots of the virtual machine environment of the application under test in response to such triggers. A snapshot may contain all values and settings that currently exist at the time of the snapshot or may contain a predefined portion or subset of values or parameters which are utilized in the analysis of the application being tested. The snapshot is stored for subsequent use. As a result, rather than starting the application under test from its beginning each and every time the application under test is being reviewed to detect and correct errors, the application under test may be started from point within the application at the end of previously captured and stored snapshots. Consequently, error identification and correction (i.e. debugging) efficiency is enhanced.

FIG. 2 schematically illustrates the implementation of virtual machine module 28 and testing tool 30. As shown by FIG. 2, virtual machine module 28 establishes a virtual machine environment 56 distinct from a host environment 52. Communication between the virtual machine environment 56 and host environment 52 is facilitated by virtual machine manager 53 and virtual machine agent 54. Within virtual machine environment 50, and operating under or within a guest operating system 56, testing tool 30 carries out testing operations upon the application under test 32 which is also running within the guest operating system 56.

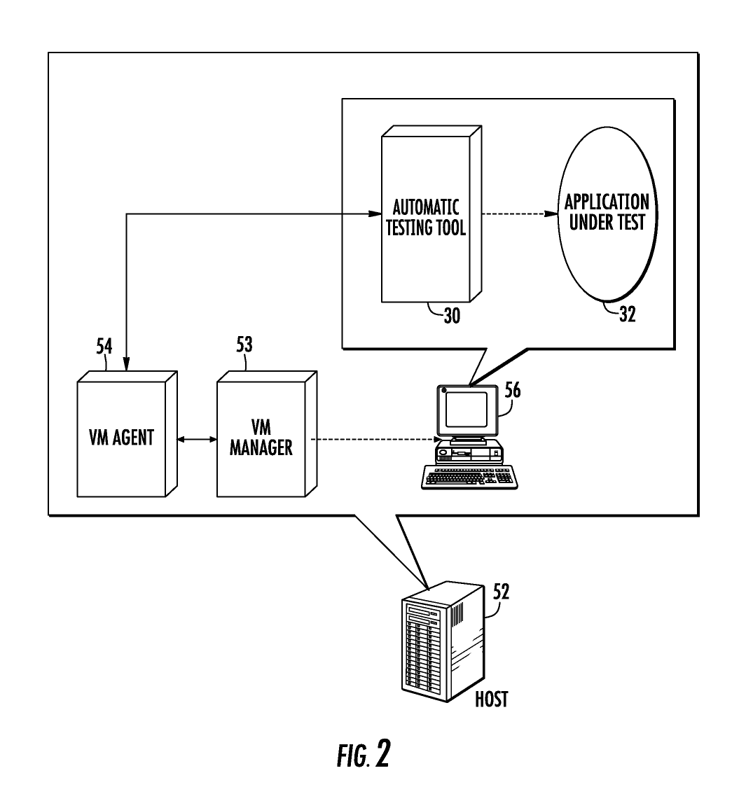

FIGS. 3 and 4 illustrate the modification of a test script for the application under test 32 to facilitate the capture of snapshots of the virtual machine environment during running of the application under test 32. FIG. 3 is a flow diagram of an example method 100 for the generation of a test script for the test tool 30. As indicated by step 102, testing tool 30 is run in the virtual machine environment 50 (shown in FIG. 2). As indicated by step 104, testing tool 30 instructs processing unit 24 to prompt a developer to identify or supply one or more trigger points to be added to a test script of the application under test 32 being run on testing tool 30. In response to receiving such inputs, testing tool 30 inserts such trigger points into the test script.

FIG. 4 schematically illustrates an example test script 120 of testing tool 30. The test script, based upon the application under test 32, contains multiple program manipulations or test inputs (TI) 122 to the application under test 32. As shown in the example, the test script based upon application under test 32 is modified using the inputs received in step 104 to insert triggers 128, 130 and 132 at selected points within the test script. In one implementation, triggers 128, 130 and 132 are inserted at various selected points by the developer through input 22. For example, a developer may identify an approximate point in the test script where an error occurred or where the developer believes in error to have occurred. In such a circumstance, the developer may insert a trigger point just prior to the point where he or she believes the error occurred, allowing the developer to rerun the test script of the application under test 32 from a point immediately preceding the point in the test script at which the developer believes air to have occurred. In another implementation, the developer may select one or more predefined time intervals, wherein test tool 30 automatically inserts such triggers at the predefined time intervals. For example, a developer may input a selected time interval of 15 minutes, wherein testing tool 30 automatically inserts a trigger after each 15 minute period of elapsed run time of the test script. As a result, the developer may select a point in to initiate or start rerunning of the test script that is, at most, 15 min. prior to the point in time at which the air is believed to occur. In one implementation, such time intervals may be uniform. In other implementations, such time intervals may have non-uniform time spacings. In one implementation, a combination of automatic interval based triggers and developer selected and placed triggers may be incorporated into test script 120.

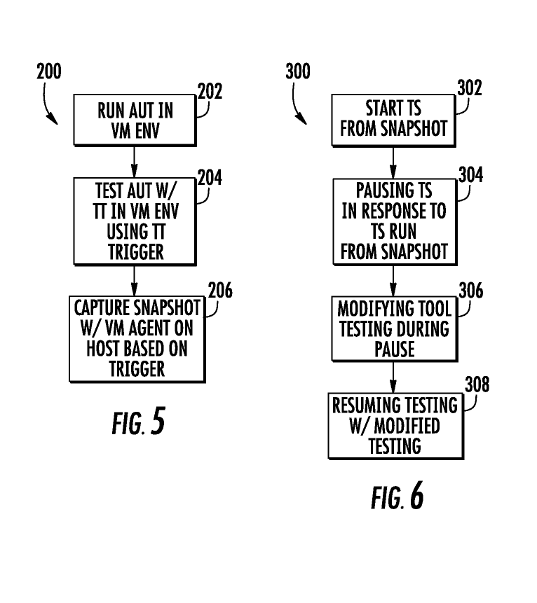

FIG. 5 is a flow diagram of an example method 200 for testing the application under test 32. As indicated by step 202, the application under test 32 is run in the virtual machine environment 50. In particular, a test script of the application under test 32 is run by testing tool 30. As indicated by step 204, the application under test is tested with the testing tool in the virtual machine environment using the testing tool trigger. As indicated step 206, the virtual machine agent 54 (shown in FIG. 2) captures a snapshot of the virtual machine environment with the test script of application under test running based on the trigger. In particular, as a test script is being run, testing tool 204, upon reaching a trigger point in the test script, notifies virtual machine agent 54. In response to receiving the notification, virtual machine agent 54 captures a snapshot of the virtual machine environment running the test script. As noted above, each captured snapshot is stored, wherein the test script may be rerun from the snapshot. In other words, the test script for the application under test 32 may be started from a point in time immediately following the snapshot. As a result, the developer may revert the environment to a snapshot closest to a discovered defect is subsequently reproduced the rest of the steps from the snapshot to reveal the defect once again for analysis.

FIG. 6 is a flow diagram of an example method 300 for the use of a previously taken snapshot for method 200. As indicated by step 302, during a rerun of the test script for the application under test 32, the test script is started from the snapshot. In other words, the test script is run from a point in time in the test script corresponding to the snapshot using all of the stored values and parameters captured as part of the snapshot (all the prior test inputs having been carried out by the application under test up to the point of the snapshot). As a result, the entire transcript up to the point of the snapshot does not need to be rerun. In one implementation, testing tool 30 (shown in FIG. 1) may prompt a person to select a stored snapshot from which the test script of the application under test 32 is to be run.

As indicated by step 304, the test execution is paused in response to the virtual machine environment being run from the snapshot. In one implementation, testing tool 30 communicates with virtual machine agent 54 discover that testing tool is running in a “restored run mode”. In response to discovering that it is running in a “restored run mode”, testing tool 30 pauses the test execution.

As indicated by step 306, during the pause of the test execution, the developer is allowed to make modifications to a testing characteristic of testing tool 30 while the test execution of the test script of the application under test 32 is paused. Although the test execution of the test script is paused, the running of the application under test 32 may continue with no further user input or manipulations being provided by the test script such that the application under test is effectively idle waiting for further user input or manipulations 122. In one implementation, during this pause, the developer may insert new triggers, may attach a debugger to the application under test 32 on tool 30 or may enable logs. As indicated by step 308, once such modifications to one or more testing characteristics of testing tool 30 have been made, the developer may resume testing of the test script of the application under test 32 using the one or more modified testing characteristics.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A computer-implemented method comprising:
testing an application under test running in a virtual machine environment with a testing tool running in the virtual machine environment, wherein the testing tool running in the virtual machine environment includes a trigger for taking a snapshot of the virtual machine environment while the application is running; and
capturing, with a virtual machine agent on a host environment, the snapshot in response to the trigger.

2. The method of claim 1 further comprising:
starting the virtual machine environment from the snapshot;
pausing execution of a test script of the testing tool in response to the testing tool being run from the snapshot;
modifying a testing characteristic of the tool while the test execution is being paused; and
resuming execution of the test script with the modified testing characteristic.

3. The method of claim 2, wherein modifying the testing characteristic of the tool comprises attaching a debugger to the application under test on the tool.

4. The method of claim 2, wherein modifying the testing characteristic of the tool comprises enabling logs.

5. The method of claim 2 further comprising receiving, by the tool, an indication from a virtual machine agent on a host environment that the application is being run from the snapshot, wherein the tool carries out the pausing in response to the indication.

6. The method of claim 1, wherein the tool includes a second trigger for taking a second snapshot of the virtual machine environment while the application under test is running and wherein the method further comprises capturing, with the virtual machine agent on the host environment, the second snapshot in response to the second trigger.

7. The method of claim 1, wherein the tool comprises a plurality of triggers.

8. The method of claim 7, wherein the plurality of triggers are at specified time intervals during execution of the application under test.

9. The method of claim 1 further comprising receiving a manual input adding the trigger to the testing tool while the testing tool is in the virtual machine environment.

10. An apparatus comprising:
a non-transient computer-readable medium comprising:
an application testing module to run in a virtual machine environment, wherein the testing module includes a trigger for taking a snapshot of the virtual machine environment while an application under test is running on the virtual machine environment.

11. The apparatus of claim 10, wherein the medium comprises a virtual machine module to run on a host environment to establish a virtual machine environment.

12. The apparatus of claim 10, wherein the application testing module includes code to:
start the virtual machine environment from the snapshot;
pause execution of a test script of the testing tool in response to the testing tool being run from the snapshot;
modify a testing characteristic of the tool while the execution of the test script is being paused; and
resume execution of the test script with the modified testing characteristic.

13. A system comprising:
a non-transient computer-readable medium comprising code to direct a processor to:
run a testing tool within the virtual machine environment; and
receive an input for the addition of a trigger to a test script of an application under test on the testing tool while the testing tool is in the virtual machine environment.

14. The system of claim 12, wherein the code directs the processor to capture, with a virtual machine agent on a host environment, a snapshot in response to the trigger.

15. The system of claim 13, wherein the code further:
starts the virtual machine environment from the snapshot;
pauses the execution of a test script of the testing tool in response to the testing tool being run from the snapshot;
modifies a testing characteristic of the tool while the execution of the test script is being paused; and
resumes execution of the test script with the modified testing characteristic.
